(19) United States
(12) Patent Application Publication
(10) Pub. No.: US 2016/0381772 A1
(43) Pub. Date: Dec. 29, 2016

(54) INFRARED EMITTER FOR AN AIRFIELD LIGHTING SYSTEM

(71) Applicant: ADB AIRFIELD SOLUTIONS LLC, Columbus, OH (US)

(72) Inventor: Edwin K. Runyon, Worthington, OH (US)

(73) Assignee: ADB AIRFIELD SOLUTIONS LLC, Columbus, OH (US)

(21) Appl. No.: 15/197,190

(22) Filed: Jun. 29, 2016

Related U.S. Application Data
(60) Provisional application No. 62/186,118, filed on Jun. 29, 2015.

(51) Int. Cl. H05B 37/02; F21V 23/04; B64F 1/20; H05B 33/08

(52) U.S. Cl. CPC H05B 37/0272; H05B 33/0845; F21V 23/0435; B64F 1/20; F21W 2111/06

(57) ABSTRACT

In an example embodiment, there is disclosed herein an airfield lighting system that employs an IR emitter. The IR emitter can be located within an airfield lighting fixture or external to the lighting fixture. Activating the IR emitter can enable an Enhanced Flight Vision System (“EFVS”) to determine the location of lighting fixtures which may be undetectable by the EFVS, such as Light Emitting Diode (“LED”) fixtures.

### CROSS REFERENCE TO RELATED APPLICATIONS

This application claims the benefit under 35 U.S.C. §119 of U.S. Provisional Application No. 62/186,118, filed on Jun. 29, 2015.

### TECHNICAL FIELD

The present disclosure relates generally to airfield lighting systems.

### BACKGROUND

Enhanced Flight Vision System (EFVS), Federal Aviation Administration (“FAA”) Advisory Circular 90-106, makes use of infrared (“IR”) to display objects on a heads-up display in an aircraft. This can provide a pilot with a real time enhanced image of the external scene topography, and allow the pilot in certain circumstances to fly below the Decision Altitude (“DA”) or Minimum Descent Altitude (MDA).

### BRIEF DESCRIPTION OF THE DRAWINGS

The accompanying drawings incorporated herein and forming a part of the specification illustrate the example embodiments.

FIG. 1 is a block diagram illustrating an example of an airfield system employing light fixtures with an IR emitter.

FIG. 2 is a block diagram illustrating an example of employing amplitude shift keying (ASK) signals for controlling an IR emitter.

FIG. 3 is a block diagram illustrating an example of frequency shift keying signals (“FSK”) for controlling an IR emitter.

FIG. 4 is a block diagram illustrating an example of an airfield system with an IR emitter that is external to a light fixture.

FIG. 5 is a block diagram illustrating an example of an IR emitter.

FIG. 6 is a block diagram illustrating an example of an alternate embodiment of a light fixture with an IR emitter.

FIG. 7 is a block diagram illustrating an example of the alternate embodiment of the light fixture with an antenna coupled with a microprocessor coupled with the light source.

FIG. 8 is a block diagram illustrating an example of the alternate embodiment of the light fixture with an antenna coupled with a microprocessor coupled with the IR emitter.

FIG. 9 is a block diagram illustrating an example of the alternate embodiment of a light fixture with an IR emitter coupled where the controller is coupled with a weather device.

FIG. 10 is a block diagram illustrating an example of a computer system upon which an example embodiment can be implemented.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an infrared (“IR”) emitter that is employed by an airfield lighting system. The IR emitter can be located within an airfield lighting fixture or external to the lighting fixture. Activating the IR emitter can enable an EFVS to determine the location of lighting fixtures which may be undetectable by the EFVS, such as Light Emitting Diode (“LED”) fixtures.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

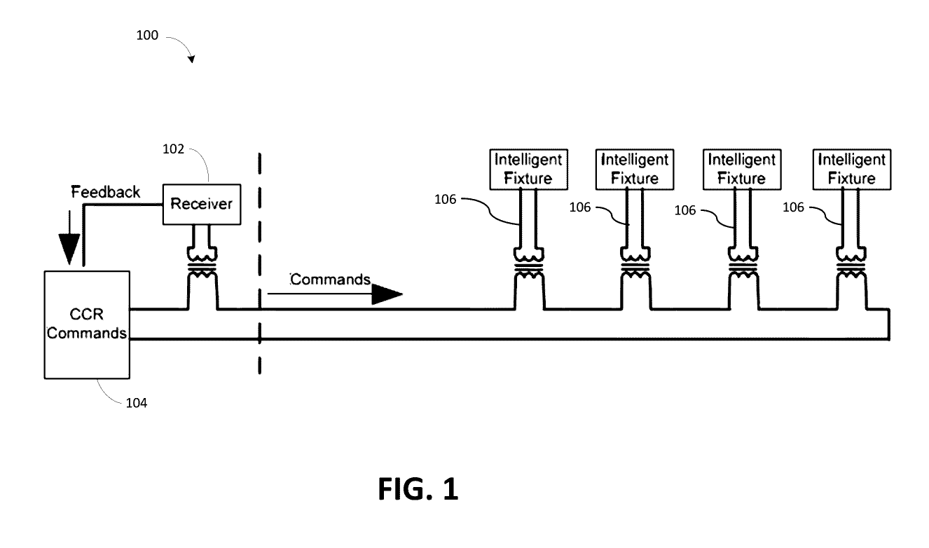

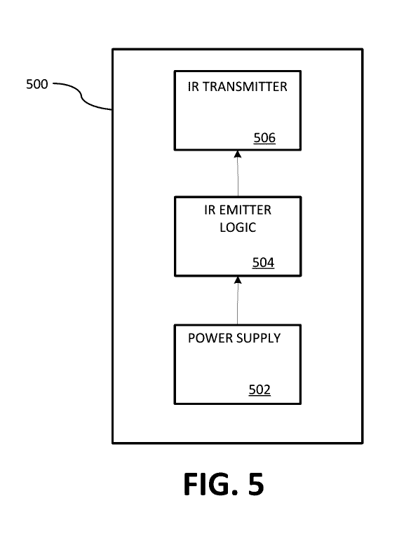

FIG. 1 is a block diagram illustrating an example of an airfield system 100 employing light fixtures 106 with an IR emitter (not shown, see e.g., FIG. 5). The airfield lighting system employs a radio controller (receiver) 102 for receiving wireless signals from an aircraft (or any other suitable source). For example, the controller may be compliant a L-854 radio controller defined in FAA AC 150/5345-49C. For example, light intensity may be based on a number of pulses (e.g., microphone clicks) received on a predefined frequency during a predetermined time period. For example, AC 150/5345-49C specifies low intensity if three clicks are received within 5 seconds, medium intensity of five clicks are received with five seconds, and high (bright) intensity if seven clicks are received within five seconds.

When the receiver in the radio controller 102 detects a predefined number of pulses on the predefined frequency, the radio controller 102 sends commands via the power supply (in this example a Constant Current Regulator or “CCR”, however, those skilled in the art should readily appreciate the principles described in the example embodiments disclosed herein may be suitably employed by any power supply) 104 to turn on the airfield lights should be turned on, and the intensity of the lights. In an example embodiment, the radio controller 102 may also send a command to activate IR emitters that are disposed within the airfield lighting fixtures 106. The command to switch on the IR emitter may be sent based on any predetermined criterion. For example, the command may be sent if the light intensity is high. Additionally, other commands may be sent to turn off the IR emitter. For example, a L-854 radio controller times out after a predefined time, so a command may be sent by the radio controller 102 through the CCR 104 to the light fixtures 106 to switch off the IR emitter.

In an example embodiment, the radio controller 102 uses Amplitude Shift Keying (“ASK”) to sends commands to (IR emitter in) the airfield lighting fixture 106. In another example embodiment, radio controller 102 employs Frequency Shift Keying (“FSK”) to send command to the (IR emitter in) the airfield light fixture 106. In particular embodiments, commands for the IR emitter employ different frequencies than commands for adjusting light intensity of the light in the airfield lighting fixture 106.

The IR emitter may be employed with any kind of light. For example, the IR emitter may be implemented within an approach light, a runway edge light. a taxiway edge light, a runway centerline touchdown zone light, a taxiway centerline light, a Runway End Identifier Light (“REIL”), or any other suitable type of airfield light.

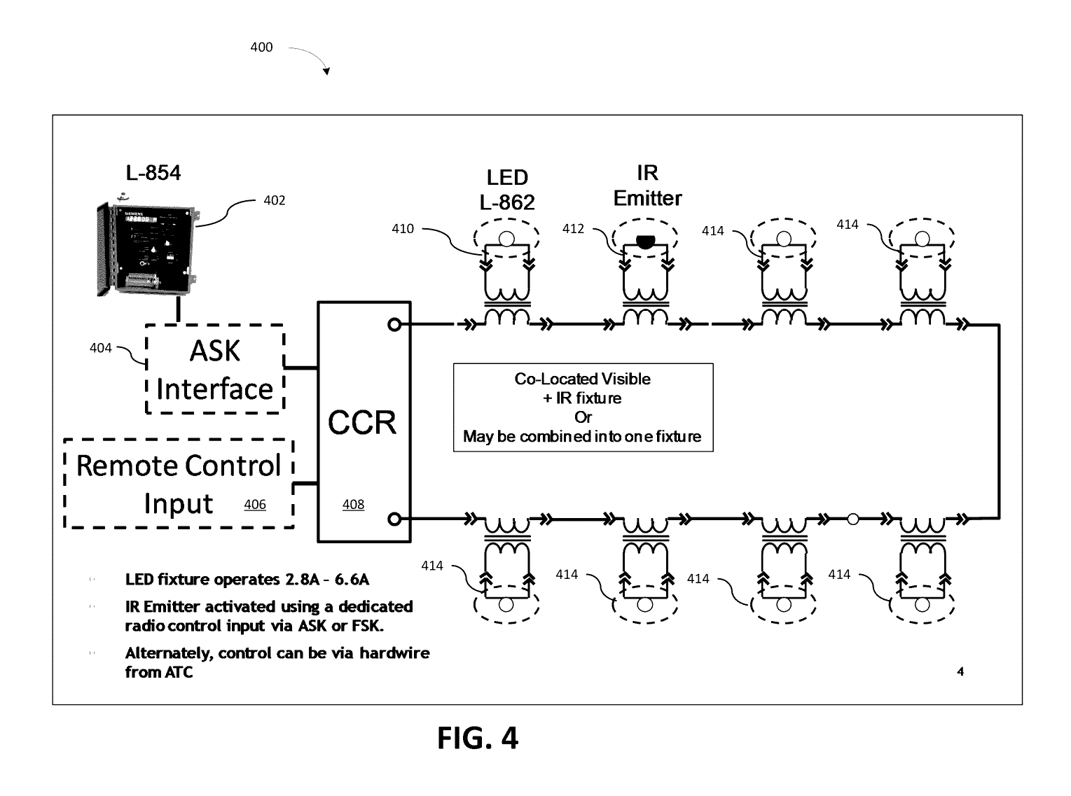

In an example embodiment, the CCR 104 may also receive commands from an external source (not shown, see e.g., FIG. 4). This can allow, for example, Air Traffic Control (“ATC”) to control the airfield lighting system, including the IR emitter within airfield lighting fixtures 106.

Although the illustrations herein, such as in FIGS. 1 and 4 illustrate a certain number of airfield lights, those skilled the art should readily appreciate that the number of fixtures selected for the examples were merely chosen for ease of illustration. Therefore, those skilled in the art should readily appreciate that the principles described herein may be employed by airfield lighting systems having as few as one light, or as many as are physically realizable.

In the illustrated example, the CCR 104 receive commands wirelessly via receiver 102. Those skilled in the art should readily appreciate the CCR 104 may be further operable to receive commands from other remote locations such as an Air Traffic Control (“ATC”) facility. In particular embodiments, the CCR 104 may be operable to receive weather data and switch on the IR emitters in the intelligent light fixtures 106 responsive to the cloud deck being below a predefined minimum threshold (e.g., 200 feet).

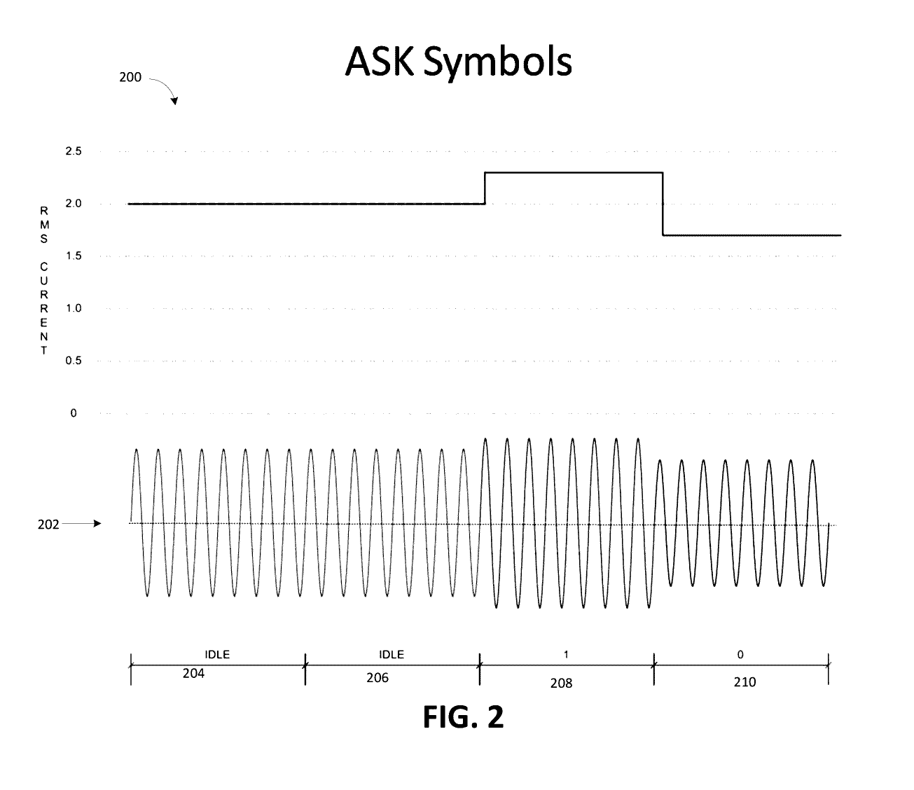

FIG. 2 is a block diagram illustrating an example of employing amplitude shift keying (ASK) signals for controlling an IR emitter. A graph 200 illustrating RMS current amplitude and an example 202 of a sine wave of varying amplitude illustrate how data can be communicated with an IR emitter using ASK. For example, during time periods 204, 206 communications are idle. Time period 208 represents a digital “one” and time period 210 illustrates a digital “zero”.

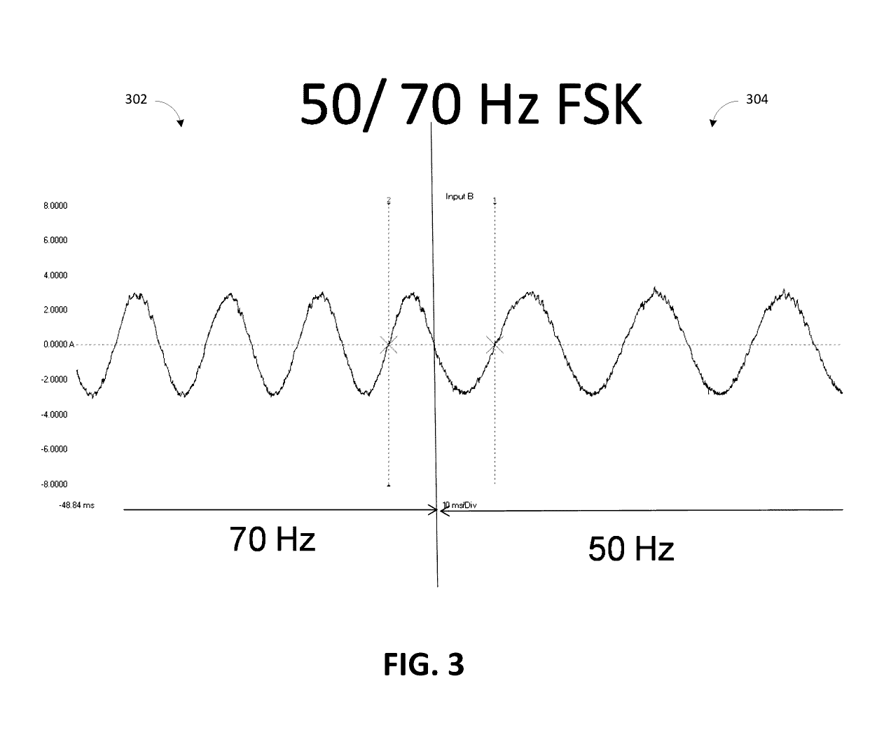

FIG. 3 is a block diagram illustrating an example of frequency shift keying signals (“FSK”) for controlling an IR emitter. In the illustrated example, a 50 Hz signal illustrated during time period 302 and a 70 Hz signal are employed for communicating with an IR emitter. However, those skilled in the art should readily appreciate that any desired frequencies may be employed for communicating with the IR emitter. In an example embodiments, the frequencies employed for communicating with light intensity of the airfield lights are sent on different frequencies than the frequencies employed for controlling the IR emitter.

FIG. 4 is a block diagram illustrating an example of an airfield lighting system 400 with an IR emitter that is external to a light fixture 410. In the illustrated example, the radio controller is a L-854 compliant controller and is coupled with an ASK interface 404 for sending commands via the CCR 408 to the light fixtures 410 (e.g., a L-862 LED light) and 414 as well as to the IR emitter 414. In an example embodiment, the IR emitter 412 is located adjacent to the light fixture 410. Light fixtures 414 may be intelligent light fixtures with internal IR emitters (like light fixtures 106 described in FIG. 1) or may employ external IR emitters (like IR emitter 412) or be a combination of light fixtures with IR emitters and light fixtures with external IR emitters. The airfield lighting system 400 further comprises a remote control input 406 that can enable an external source to control the airfield lighting system 400. For example, the remote control input 406 may receive commands from a control tower or ATC.

When the radio controller 402 receives a predefined number of pulses on the predefined frequency, the radio controller 402 sends commands via the ASK interface 404 that pass through the power supply (in this example a Constant Current Regulator or “CCR” 408, however, those skilled in the art should readily appreciate the principles described in the example embodiments disclosed herein may be suitably employed by any power supply) 408 to turn on the airfield lights should be turned on, and the intensity of the lights. In an example embodiment, the radio controller 402 may also send a command to activate IR emitter 412 and any IR emitters that are disposed within the airfield lighting fixtures 414. The command to switch on the IR emitter may be sent based on any predetermined criterion. For example, the command may be sent if the light intensity is high. Additionally, other commands may be sent to turn off the IR emitter. For example, a L-854 radio controller times out after a predefined time, so a command may be sent by the radio controller 402 through the CCR 104 to the light fixtures 106 to switch off the IR emitter.

In an example embodiment, the radio controller 402 uses Amplitude Shift Keying (“ASK”) to sends commands to (IR emitter in) the IR emitter 412. In another example embodiment, radio controller 402 employs Frequency Shift Keying (“FSK”) to send command to the IR emitter in 412. In particular embodiments, commands for the IR emitter employ different frequencies than commands for adjusting light intensity of the lights in the airfield lighting fixtures 410, 414.

The IR emitter may be employed with any kind of light. For example, the IR emitter may be implemented within an approach light, a runway edge light. a taxiway edge light, a runway centerline touchdown zone light, a taxiway centerline light, a Runway End Identifier Light (“REIL”), or any other suitable type of airfield light.

In an example embodiment, the CCR 408 may also receive commands from an external source (Remote Control Input) 406. This can allow, for example, Air Traffic Control (“ATC”) to control the airfield lighting system, including the IR emitter 412.

FIG. 5 is a block diagram illustrating an example of an IR emitter 500. The IR emitter 500 comprises a power supply 502. In embodiments where the IR emitter is co-located within an airfield lighting fixture, the power supply 502 may be the airfield lighting fixture's power supply.

IR emitter logic 504 is operable to receive commands via the power supply 502. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the desired functionality when executed by a processor.

In an example embodiment, commands are received via ASK signals (see e.g., FIG. 2). In another example embodiment, commands are received FSK signals (see e.g., FIG. 3).

In response to the signals received via power supply 502, IR emitter logic 504 is operable to either switch on or switch off the IR transmitter 506. If the IR emitter 500 is co-located within an airfield lighting fixture, the IR emitter 500 may be switched on and off independently of the light.

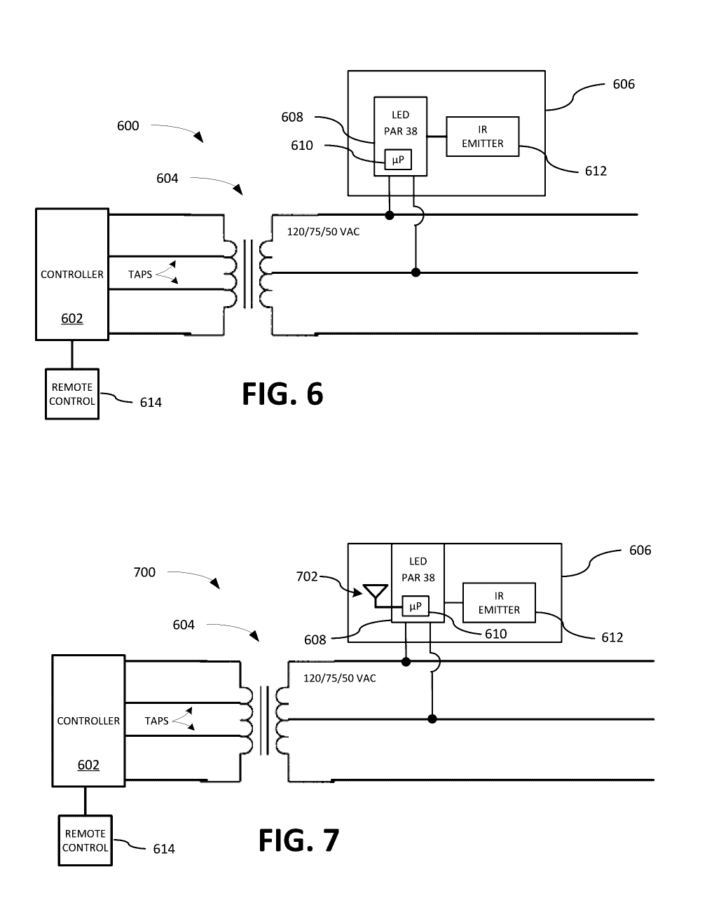

FIG. 6 is a block diagram illustrating an example of an alternate embodiment of a light fixture 606 with an IR emitter 612. The system 600 in the illustrated example is a simplified example of a MALSR (Medium Approach Light System with Runway Alignment Indicator Lights). A typical MALSR uses 18 lamps (PAR 56) along the runway threshold spaced 10′ apart, 9 light bars with 5 lights (PAR 38) separated every 200′ and 5 sequenced flashers also separated every 200′ over a distance of 2,400′ from the runway threshold. At the 1,000′ point there are three light bars (15 lamps) for added visual reference for the pilot on final approach. Sequenced flashing lights provide added visual guidance down the runway centerline path. Planned approach visibility is at least 1,800′ to 0.5 miles, with a (current) decision height of 200′.

The system 600 comprises a controller that is coupled to a transformer 604. The controller is coupled with taps on the primary side of the transformer 604 employs the windings to control the output voltage on the secondary side of the transformer 604. For a MALSR, typical output voltages are 120, 75, and 50 VAC for high, medium, and low intensity light respectively.

Light unit 606 is coupled with a secondary winding of transformer 604. Although the illustrated example shows a transformer with a center tap, those skilled in the art should readily appreciate that any suitable transformer configuration can be employed and that the principles described herein should not be construed as limited by the layout of the illustrated example.

The light unit 606 comprises a light source, such as a light emitting diode (“LED”) 608, a microprocessor (or other suitable logic) 610 coupled with the LED 608, and an IR emitter 612. The microprocessor 610 is operable to control the operation of the IR emitter 612.

In an example embodiment, the microprocessor 610 is operable to switch the IR emitter 612 on based on the current light intensity. For example, the microprocessor 610 may switch the IR emitter 612 on when the light is at high intensity (e.g., 110VAC from transformer 604). In other embodiments, the microprocessor 610 may switch IR emitter 612 on when the light intensity is medium or higher. in still yet other embodiments, the microprocessor 610 may switch the IR emitter on whenever the LED 608 is illuminated. In particular embodiments, the MALSR is a sequential flashing light, the microprocessor 610 is operable to switch the IR emitter on when the LED is illuminated and other criteria (e.g., based on the light intensity and/or other criteria as will be explained herein infra) are met.

In an example embodiment, a remote control module 614 may be coupled with controller 602. The remote control module 614 may be operable to receive signals from external sources, such as ATC, that contain commands for operating the light fixture 606.

FIG. 7 is a block diagram illustrating an example of the alternate embodiment 700 illustrating a light fixture 606 with an antenna 702 coupled with a microprocessor 610 coupled with the light source 608. The antenna 702 allows the light unit 606 to receive signals from external sources to control the operation of the IR emitter 612. In an example embodiment, the light unit 606 may be part of a network, such as a ZIGBEE (IEEE 802.15.4) or other type of mesh network.

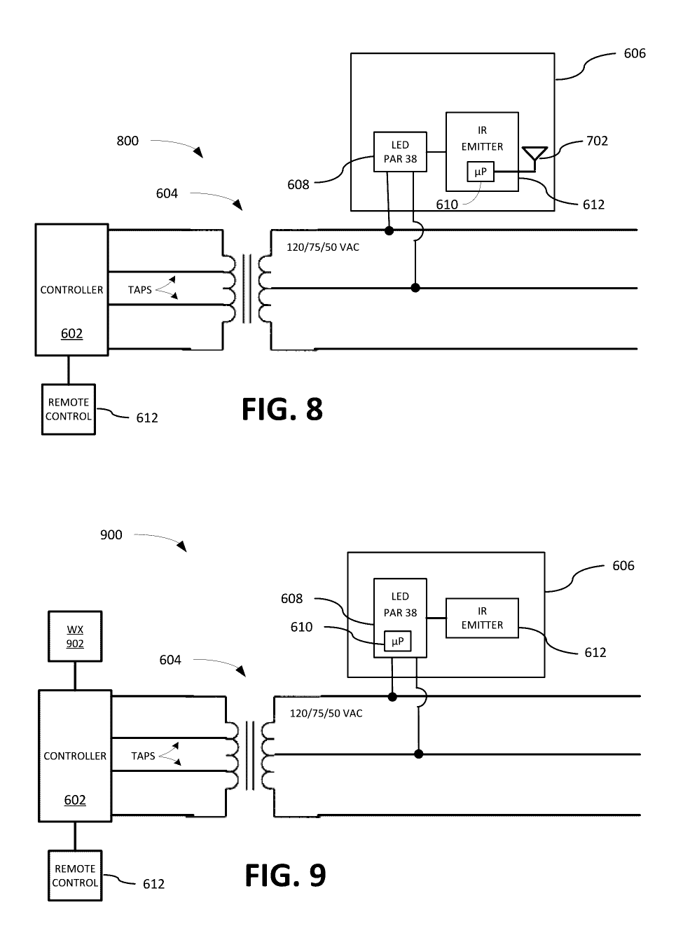

FIG. 8 is a block diagram illustrating an example of the alternate embodiment of the light fixture 606 with an antenna 702 coupled 702 with a microprocessor 610 coupled with the IR emitter 612. The antenna 702 allows the IR emitter 612 to receive signals from external sources to control the operation of the IR emitter 612. In an example embodiment, the light unit 606 may be part of a network, such as a ZIGBEE (IEEE 802.15.4) or other type of mesh network.

FIG. 9 is a block diagram illustrating an example of the alternate embodiment 900 of a light fixture 606 with an IR emitter 612 where the controller 602 is coupled with a weather device 902. Many airports have automated weather reporting systems. Weather device 902 may be coupled with the automated weather reporting system and is operable to receive weather data from the automated weather reporting system. In an example embodiment, the controller 602 is operable to send a command to switch the IR emitter 612 on responsive to receiving data representative of a cloud deck indicating the cloud deck is below a predetermined threshold. For example, the IR emitter 612 and/or LED 608 may be automatically switched on when the cloud deck is below two hundred feet.

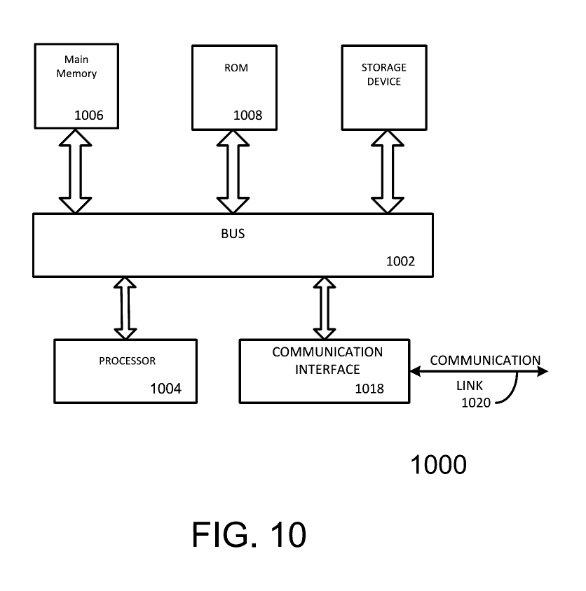

FIG. 10 is a block diagram illustrating an example of a computer system 1000 upon which an example embodiment can be implemented. For example, computer system 1000 can be employed to implement the receiver 102, CCR 104, and the logic fixtures 106 in FIG. 1; receiver 402, ASK interface 404, CCR 408, and IR emitter 412 in FIG. 4; IR emitter logic 504 in FIG. 5; controller 602 (FIGS. 6-9); microprocessor 610 (FIGS. 6-9); remote control 614 (FIGS. 6-9); and the logic for the weather device 902 in FIG. 9.

Computer system 1000 includes a bus 1002 or other communication mechanism for communicating information and a processor 1004 coupled with bus 1002 for processing information. Computer system 1000 also includes a main memory 1006, such as random access memory (RAM) or other dynamic storage device coupled to bus 1002 for storing information and instructions to be executed by processor 1004. Main memory 1006 also may be used for storing a temporary variable or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

An aspect of the example embodiment is related to the use of computer system 1000 for using an IR emitter with an airfield lighting system. According to an example embodiment, using an IR emitter with an airfield system is provided by computer system 1000 in response to processor 1004 executing one or more sequences of one or more instructions contained in main memory 1006. Such instructions may be read into main memory 1006 from another computer-readable medium, such as storage device 1010. Execution of the sequence of instructions contained in main memory 1006 causes processor 1004 to perform the process steps described herein. One or more processors in a multi-processing arrangement may also be employed to execute the sequences of instructions contained in main memory 1006. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 1004 for execution. Such a medium may take many forms, including but not limited to non-volatile media. Non-volatile media include for example optical or magnetic disks, such as storage device 1010. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 1000 also includes a communication interface 1018 coupled to bus 1002. Communication interface 1018 provides data communication coupling computer system 1000 to a communication link 1020 that is connected to a local network 1022. In an example embodiment, communications are carried out over a power link, thus communication interface 1018 is operable to receive commands over a power link using any suitable protocol such as ASK or FSK.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed herein and in any applications claiming priority hereto interpreted in accordance with the breadth to which they are fairly, legally and equitably entitled.

1. An airfield lighting system, comprising:
a radio controller;
an airfield lighting fixture comprising a light source;
a constant current regulator (“CCR”) coupled with the radio controller and the airfield lighting fixture, the CCR is operable provide power to the airfield lighting fixture; and
an infrared (“IR”) emitter coupled with the airfield lighting fixture;
wherein the radio controller is operable to send commands via the CCR to switch on the IR emitter; and
wherein the IR emitter is responsive to the command to switch on.

2. The airfield light system set forth in claim 1, wherein amplitude shift keying is employed to send commands to the IR emitter.

3. The airfield lighting system set forth in claim 1, wherein Frequency Shift Keying is employed to send commands to the IR emitter.

4. The airfield lighting system set forth in claim 3, wherein commands for the IR emitter employ a first frequency commands for adjusting light intensity of the light employ a second frequency.

5. The airfield lighting system set forth in claim 1, wherein the IR emitter is located inside of the airfield lighting fixture.

6. The airfield lighting system set forth in claim 1, wherein the IR emitter is located external to the airfield lighting fixture.

7. The airfield lighting system set forth in claim 6, wherein the IR emitter is located adjacent to the airfield lighting fixture.

8. The airfield lighting fixture set forth in claim 1, wherein the airfield lighting fixture is an approach light.

9. The airfield lighting fixture set forth in claim 1, wherein the airfield lighting fixture is a runway edge light.

10. The airfield lighting fixture set forth in claim 1, wherein the airfield lighting fixture is a taxiway edge light.

11. The airfield lighting fixture set forth in claim 1, wherein the airfield lighting fixture is a runway centerline touchdown zone light.

12. The airfield lighting fixture set forth in claim 1, wherein the airfield lighting fixture is a taxiway centerline light.

13. The airfield lighting fixture set forth in claim 1, wherein CCR sends the command to switch on the IR emitter when data is received from the radio receiver to switch the light to a certain intensity.

14. The airfield lighting fixture set forth in claim 1, wherein the CCR is operable to receive commands controlling the IR emitter from a remote air traffic control (“ATC”) facility.

15. The airfield lighting fixture set forth in claim 1, further comprising:
a weather device coupled with the CCR, the weather device is operable to obtain data representative of a cloud deck;
the CCR is operable to send a command to switch the IR emitter on responsive to the data representative of a cloud deck indicating a cloud deck below a predetermined minimum threshold.

16. An apparatus, comprising:
a light unit that comprises a light emitting diode (“LED”) light source and an infra-red (“IR”) emitter;
wherein the light source is operable to selectively output light at a light intensity that is selected from one of a plurality of light intensities; and
wherein the IR emitter is operable to switch on when the light intensity exceeds a predefined light intensity threshold.

17. apparatus set forth in claim 16, further comprising an antenna coupled with the light source;
wherein the light source is operable to receive wireless signals via the antenna to control the operation of the IR emitter.

18. The apparatus set forth in claim 16, further comprising an antenna coupled with the IR emitter;
wherein the IR emitter is operable to receive signals via the antenna for controlling the operation of the IR emitter.

19. The apparatus set forth in claim 16, a further comprising controller coupled with the light unit;
wherein the controller is operable to control the light intensity of the light source by varying the voltage provided to the light unit.

20. The apparatus set forth in claim 19, further comprising:
a weather device coupled with the controller , the weather device is operable to obtain data representative of a could deck; and
the controller is operable to send a command to switch the IR emitter on responsive to the data representative of a cloud deck indicating a cloud deck below a predetermined minimum threshold.
